(19) United States
(12) Patent Application Publication
(10) Pub. No.: US 2004/0030430 A1
(43) Pub. Date: Feb. 12, 2004

(54) Waferless metrology recipe generator and generating method

(76) Inventor: Ryoichi Matsuoka, Chiba-shi (JP)

Correspondence Address: ADAMS & WILKS, 31st Floor, 50 Broadway, New York, NY, 10004, US

(21) Appl. No.: 10/607,295

(22) Filed: Jun. 26, 2003

(30) Foreign Application Priority Data
Jun. 27, 2002 (JP) 2002-187015

(51) Int. Cl. G06F 19/00

(52) U.S. Cl. 700/108

(57) ABSTRACT

A metrology recipe generator is offered which is capable of automatically creating a metrology recipe without halting the operation of the production line. The metrology recipe is used to carry out SEM-based dimensional metrology for evaluating patterns transferred onto wafers according to CAD data. The generator has a CAD alignment-specifying portion for specifying alignment in CAD according to CAD data and a CAD metrology position-specifying portion for specifying both the coordinates of positions on the wafers on which metrology measurements are made and a metrology type. The metrology recipe is created according to data from the CAD alignment-specifying portion and from the CAD metrology position-specifying portion.

### BACKGROUND OF THE INVENTION

1. Field of the Invention

The present invention relates to a waferless metrology recipe generator and a generating method for managing the finish of patterns transferred onto wafers.

2. Description of the Related Art

When there arises the need to inspect whether patterns formed on wafers have intended geometries in semiconductor fabrication steps, metrology SEMs have been heretofore used. Lengths such as pattern widths and pattern spacings are measured by these tools. The finished pattern geometries are evaluated based on the results of the metrology measurements. In recent years, however, miniaturization has progressed in semiconductor fabrication equipment and so a large amount of labor has been required to observe and evaluate patterns by metrology SEMs. Accordingly, the observation and evaluation have been conducted as follows. A pattern position to be measured by a metrology SEM is placed in position on the metrology SEM using a wafer that will become a finished product in practice. Recipe information for automation is created. A desired SEM image is obtained according to the created recipe information, for the observation and evaluation.

In this way, in the past, a worker obtains low- and high-magnification images at given checkpoints on a fabricated wafer within a clean room at a wafer fabrication site. A metrology location is determined from the images, and a recipe is created. Therefore, during fabrication of the recipe, the equipment is temporarily placed out of in-line operation. The recipe is created manually. Consequently, the efficiency of automation has been deteriorated in the fabrication sequence.

Furthermore, the observed subject on a wafer is placed in position at a wafer fabrication site. Therefore, limitations are placed on the measured locations. This presents another problem that pattern geometries cannot be sufficiently measured.

### SUMMARY OF THE INVENTION

It is an advantage of the present invention to provide a waferless metrology recipe generator capable of automatically creating a metrology recipe for evaluating the geometries of transferred patterns formed on fabricated wafers without halting the operation of the manufacturing line.

The present invention provides a waferless metrology recipe generator for creating a metrology recipe used to implement SEM-based dimensional metrology that evaluates transferred patterns formed on wafers according to CAD data. The recipe generator has alignment-specifying means for specifying alignment in CAD based on the CAD data, coordinate-specifying means for specifying the coordinates of positions on a wafer where metrology measurements should be performed, metrology type-specifying means for specifying a metrology type for each specified coordinate, and recipe creation means for creating the metrology recipe in response to the alignment-specifying means, coordinate-specifying means, and metrology type-specifying means.

In the present invention, a recipe for specifying an observational position where the geometry of a pattern transferred onto a semiconductor wafer is observed using an electron microscope is automatically created using CAD data. This makes it unnecessary to halt the operation of the production equipment. Consequently, full automation and efficient operation of production are enabled. Furthermore, metrology locations can be specified in CAD data. Hence, measurements can be optimized. Yield management can be run optimally.

### BRIEF DESCRIPTION OF THE DRAWINGS

FIG. 1 is a schematic view of an automated metrology SEM system according to one embodiment of the present invention;

FIG. 2 is a detailed block diagram of a metrology recipe creation portion shown in FIG. 1;

FIG. 3 is a detailed block diagram of a metrology SEM portion shown in FIG. 1; and

FIG. 4 is a flowchart illustrating the operation of the automated metrology SEM system shown in FIG. 1.

### DETAILED DESCRIPTION OF THE INVENTION

An embodiment of the present invention is hereinafter described in detail with reference to the drawings.

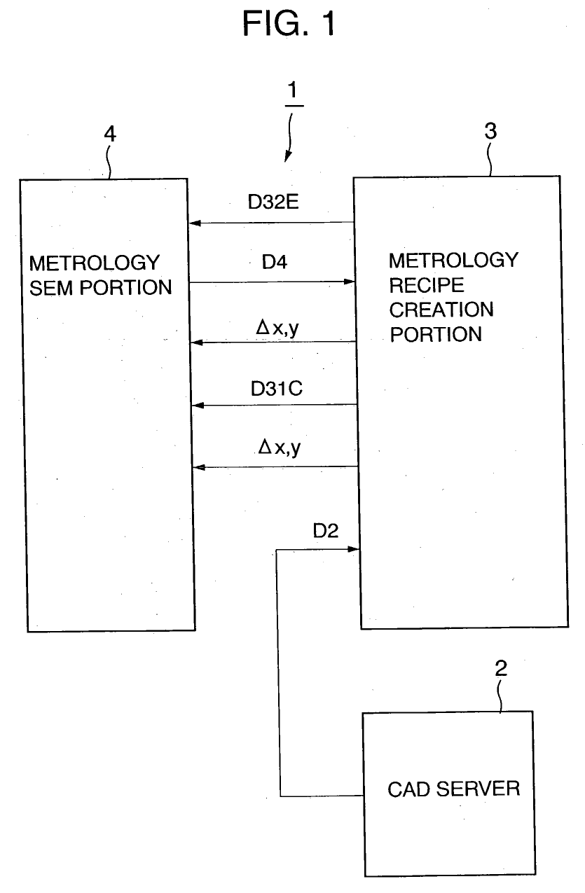

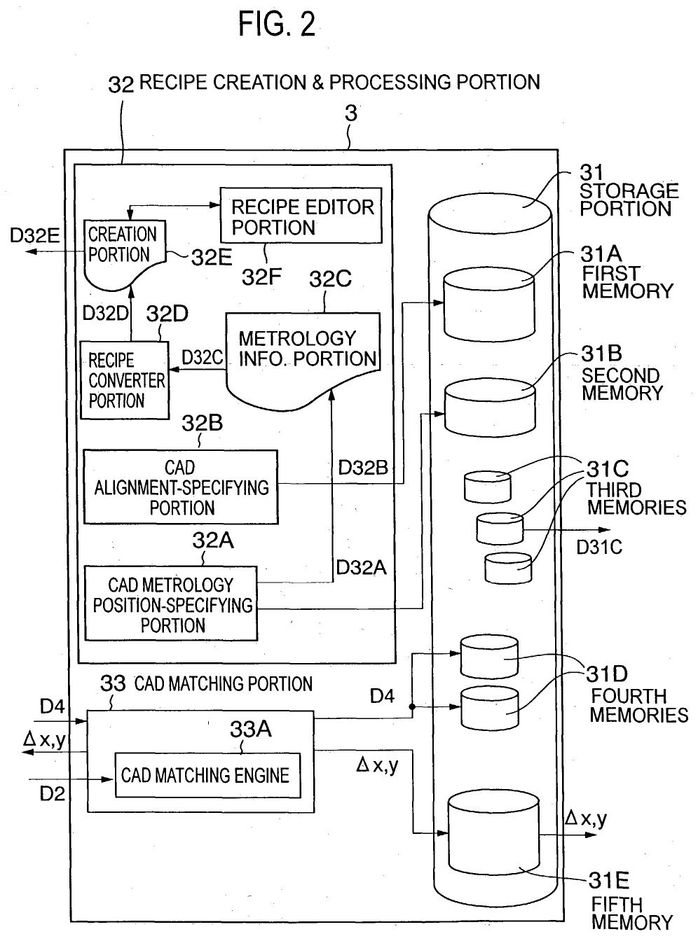

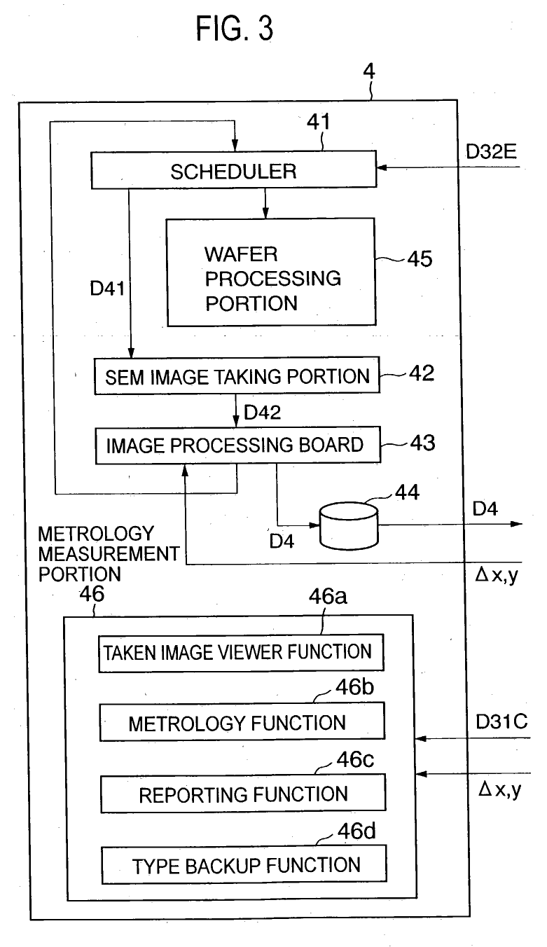

FIG. 1 is a schematic view showing the configuration of an automated metrology SEM system according to the invention. FIG. 2 is a detailed block diagram of the metrology recipe creation portion of FIG. 1. FIG. 3 is a detailed block diagram of the metrology SEM portion of FIG. 1.

The automated metrology SEM system, generally indicated by reference numeral 1, is described by referring to FIGS. 1-3. The SEM system 1 is an instrument for evaluating the geometries of actual patterns by measuring the widths or spacing of these transferred patterns formed on wafers according to given CAD data. The SEM system 1 is made up of a CAD server 2 for storing the CAD data, a metrology recipe creation portion 3 for reading desired CAD data from the CAD server 2 and automatically creating a recipe according to the CAD data to specify observation positions on the wafers, and a metrology SEM portion 4 for taking desired SEM images of wafer surfaces according to the metrology recipe created by the metrology recipe creation portion 3 and performing metrology measurements of the specified locations.

The metrology recipe creation portion 3 is now described. This portion 3 has a storage portion 31 for storing various kinds of data. The storage portion 31 has a first memory 31A for storing alignment data indicating the correspondence in coordinates between each wafer and CAD data, a second memory 31B for storing data about the coordinates of observed points on the wafer, thirdmemories 31C for storing data about metrology points, fourth memories 31D for storing data about images of the wafer derived by the metrology SEM portion 4 as described later, and a fifth memory 31E for storing matching data Δx, y for making a matching between the coordinates of a transferred pattern on the surface of the wafer and the coordinates of a transferred pattern in the CAD data.

Indicated by numeral 32 is a recipe creation portion having a CAD metrology position-specifying portion 32A for producing instruction data D32A for indicating metrology positions according to CAD data, a CAD alignment-specifying portion 32B for producing data D32B for specifying alignment mark positions on the wafer (not shown) according to the CAD data, and a metrology information portion 32C for preparing information for metrology in response to the instruction data D32A.

The metrology information data D32C from the metrology information portion 32C is sent to a recipe converter portion 32D, where the data is converted into a given format. Then, the data is sent as recipe data D32D to the creation portion 32E. Indicated by symbol 32F is a recipe editor portion that edits the recipe data D32D sent to the creation portion 32E from the recipe converter portion 32D and performs editing processing such that the recipe data assumes an appropriate form. Metrology recipe data D32E prepared by the creation portion 32E in this way and indicating a metrology recipe is sent to the metrology SEM portion 4.

The metrology recipe creation portion 32 further includes a CAD matching portion 33, which in turn has a CAD matching engine 33A for making a matching between the transferred pattern formed on the wafer and a transferred pattern contained in the, CAD data D2 from the CAD server 2. The CAD matching portion 33 also has a communication function for exchanging data with the metrology SEM portion 4. The CAD matching portion 33 has a function of accepting SEM image data D4 about the wafer obtained by the metrology SEM portion 4 as described later and storing the data in the fourth memories 31D and a function of storing matching data Δx, y obtained by the CAD matching engine 33A in the fifth memory 31E. If necessary, the CAD matching portion 33 can send the matching data Δx, y to the metrology SEM portion 4.

The metrology SEM portion 4 has a scheduler 41 for receiving the metrology recipe data D32E and determining an observation order for efficiently carrying out positioning into a plurality of observed points, an SEM image taking portion 42 for taking SEM images of the specified observed points according to schedule data D41 from the scheduler 41, and an image processing board 43 for performing processing to remove noise from the SEM image data D42 taken by the SEM image taken portion 42.

The SEM image data D4 which is output from the image processing board 43 and from which a clear image having only a small amount of noise can be obtained is stored in an image memory 44. If desired, the SEM image data D4 can be read from the metrology recipe creation portion 3.

Indicated by 45 is a wafer processing portion for loading, aligning, and unloading wafers according to instructions from the scheduler 41.

The metrology SEM portion 4 further includes a metrology measurement portion 46 that is supplied with metrology point data D31C indicating metrology points from the third memories 31C of the metrology recipe creation portion 3. Furthermore, matching data Δx, y is supplied to the metrology measurement portion 46 from the fifth memory 31E. The metrology measurement portion 46 is so designed that it can perform image viewer function 46a for the taken image, metrology function 46b for measuring pattern linewidths and line spacing, reporting function 46c for delivering the results of metrology measurements as reports, and type backup function 46d. Thus, given metrology measurements are made on the metrology points according to the metrology point data D31C. In this kind of metrology SEM system, the structure of the metrology measurement portion 46 having the aforementioned functions for metrology measurements is known per se. Therefore, the structure and operation of the metrology measurement portion 46 will not be described in further detail.

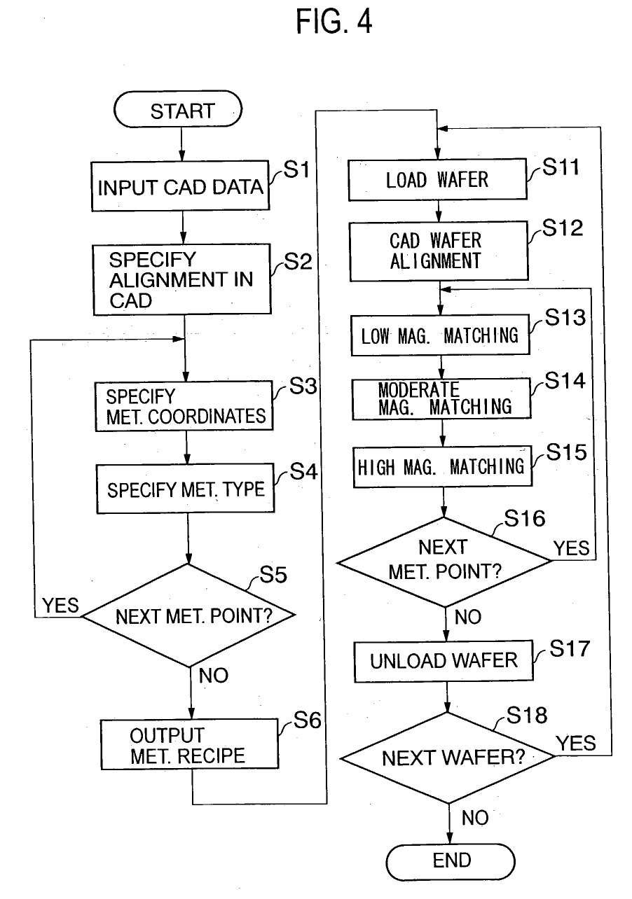

The operation of the automated metrology SEM system 1 is next described by referring to FIG. 4. In FIG. 4, steps S1-S6 illustrate the operation of the metrology recipe creation portion 3. Steps S11-S18 illustrate the operation of the metrology SEM portion 4.

When the operation of the automated SEM system 1 is started, CAD data about a pattern to be transferred onto a wafer and to be observed is first read from the CAD server 2 and entered, in step S1. In step S2, the entered CAD data is sent to the CAD alignment-specifying portion 32B, where an alignment is specified in the CAD data.

The program then enters step S3, where metrology coordinates are specified. In step S4, a metrology type used here is specified. The processing steps in steps S3 and S4 are executed by the CAD metrology position-specifying portion 32A. In step S5, a decision is made as to whether there is, a next metrology point. If there is, the result of the decision is YES. In steps S3 and S4, metrology coordinates of the next metrology point are specified and a metrology type is specified. After designation of coordinates and metrology types of all metrology points is completed, the result of the decision of step S5 is NO. The program then enters step S6, where a metrology recipe is output by the metrology information portion 32C, recipe converter portion 32D, metrology recipe creation portion 32E, and recipe editor portion 32F. Metrology recipe data 32E is sent to the metrology SEM portion 4.

The operation of the metrology SEM portion 4 that has received the metrology recipe data D32E is next described.

In step S11, a wafer (not shown) is loaded. In step S12, the wafer is aligned according to alignment specifications made in S2. In next steps S13-S15, low-, moderate-, and high-magnification matchings are respectively made about one observation point. In step S16, a decision is made as to whether there is a next observation point specified in the metrology recipe. If there is, the result of the decision in step S16 is YES. Steps S13-S15 are carried out for the next observation point. When matchings about all the observation points are completed in this way, the result of the decision in step S16 is NO. The program then proceeds to step S17.

In step S17, the wafer is unloaded. In step S18, a decision is made as to whether there is a next wafer. If there is, the result of the decision in step S18 is YES. The program goes back to step S11 and steps S11-S17 are carried out for the next wafer. When taking of desired SEM images of all wafers is completed in this way, the result of the decision in step S18 is NO. The operation of the automated metrology SEM system 1 ends.

In this way, a metrology recipe is automatically created according to CAD data. SEM images are automatically taken according to this recipe. Therefore, equipment downtime that would normally be required to create a recipe is dispensed with. This achieves fully automated operation of production steps. As a result, production can be run efficiently. The fabrication costs can be curtailed.

Furthermore, since metrology locations can be specified in CAD data, optimum pattern positions and geometries can be defined as metrology locations. Therefore, sufficient metrology measurements of pattern geometries can be accomplished. In addition, yield management can be run optimally.

According to the present invention, a metrology recipe can be automatically created according to CAD data. SEM images are automatically taken according to this recipe. Therefore, equipment downtime that would normally be required to create a recipe is dispensed with. In consequence, fully automated operation of production steps can be attained. As a result, production can be run efficiently. The production costs can be reduced. In addition, metrology locations can be specified in CAD data. Therefore, optimum pattern positions and geometries can be defined as metrology locations. Hence, sufficient metrology measurements of pattern geometries can be accomplished. Additionally, yield management can be run optimally.

What is claimed is:

1. A waferless metrology recipe generator for creating a metrology recipe used to implement SEM-based dimensional metrology that evaluates a pattern transferred onto a wafer according to CAD data, the recipe generator comprising:
alignment-specifying means for specifying alignment in CAD based on the CAD data;
coordinate-specifying means for specifying coordinates of positions on the wafer where metrology should be performed;
metrology type-specifying means for specifying a metrology type for each specified coordinate; and
recipe creation means for creating the metrology recipe in response, to the alignment specifying means, coordinate specifying means, and metrology type-specifying means.

2. A waferless metrology recipe generating method for creating a metrology recipe used to implement SEM-based dimensional metrology that evaluates a pattern transferred onto a wafer according to CAD data, the recipe generating method comprising the steps of:
specifying alignment in CAD based on the CAD data;
specifying coordinates of positions on the wafer where metrology should be performed;
specifying a metrology type for each specified coordinate; and
creating the metrology recipe in response to the specified alignment, specified coordinate, and specified metrology type.
